(19) United States
(12) Patent Application Publication
(10) Pub. No.: US 2005/0275124 A1
(43) Pub. Date: Dec. 15, 2005

(54) Insulated concrete form systems and methods of making and using the same

(76) Inventor: Kenneth Franklin, Fayetteville, GA (US)

Correspondence Address: WINSTON & STRAWN LLP, 1700 K STREET, N.W., WASHINGTON, DC, 20006, US

(21) Appl. No.: 10/867,425

(22) Filed: Jun. 14, 2004

(51) Int. Cl. E04B 1/16; B28B 3/00

(52) U.S. Cl. 264/31; 264/333

(57) ABSTRACT

An insulated concrete form system and method of making the same that comprises a first generally flat insulating form panel, a second generally flat insulating form panel, a plurality of tying members, and an amount of concrete between the first and second panels. The first panel comprises at least a first layer comprising paperboard, a second layer comprising foam, and a third layer comprising paperboard. The second panel comprises at least a fourth layer comprising paperboard, a fifth layer comprising foam, and a sixth layer comprising paperboard. The panels are attached via a plurality of tying members.

### FIELD OF THE INVENTION

The present invention is directed to insulating concrete form systems and methods of forming an insulated concrete form system. More particularly, the present invention relates to methods of making an insulated concrete form system using polymeric foams.

### BACKGROUND OF THE INVENTION

The invention is generally directed to insulated concrete forms (ICF) used in the construction of buildings and other structures. Types of common concrete form systems include form panels made of: wood, aluminum, and polystyrene foam. Popular modern-day ICF materials are foam boards that are often manufactured from a polystyrene polymer. Foamed polystyrene boards have insulating properties associated therewith. These foam boards may further include laminated outer coatings or facers. The laminated outer coating, if used, functions primarily to protect the foamed polystyrene polymer and provide the foam board with enhanced protection, durability, strength, and resiliency.

To form an insulated concrete form system, the foamed polystyrene panels are generally installed in pairs so as to form a cavity between them. The width of the cavity is the desired width of the concrete structure to be poured. A plurality of tying members keeps the panels from blowing out when concrete is poured between the panels. Concrete is then poured between the foamed polystyrene panels. The foamed polystyrene panels remain to create insulating layers for the concrete structure. While the ICF systems are lightweight and have insulating properties, the foam panels are significantly smaller than typical wood or aluminum concrete form panels. Foam panels also require more tying members between panels than wood or aluminum panels require. In a typical aluminum panel system, tying members are required about every 36 inches. Typically in a wood panel system ties are located about every 24 inches, while in an existing ICF system tying members are required about every 8 inches. These additional ties add to the cost of an ICF system.

Additional tying members are required in an existing ICF to provide the required stiffness in the form to prevent or inhibit the panels from failing under the pressure from the poured concrete. This same pressure also requires that the size of the existing ICF foam panels remain significantly smaller than wood or aluminum form system panels so that the walls will remain flat. For example, a typical aluminum panel used in a concrete form system is 36 inches in width by 96 inches in height, while an existing ICF system panel is typically from 48 inches in width by 8 inches to 12 inches in height. The smaller panel size increases the labor costs to assemble an ICF system.

Current insulated concrete forms use foam panels that provide more insulation than is required for most applications. This over-insulation occurs because the thickness of the foam panel is usually determined by the strength required to maintain the shape of the form when concrete is poured, not the proper insulating value (R-value).

It would be desirable to have an insulated concrete form (ICF) and a method of forming an insulated concrete form (ICF) system that allows for a larger sized panel and requires fewer tying members, while retaining the lightweight and insulating properties of an existing polystyrene foam panel ICF system.

### SUMMARY OF THE INVENTION

A method of forming an insulated concrete structure that provides a first generally flat insulating panel that comprises at least a first layer, a second layer, and a third layer. The first layer is paperboard. The second layer is a foam layer. The third layer is paperboard. The method additionally provides a second generally flat insulating form panel that comprises at least a fourth layer, a fifth layer, and a sixth layer. The fourth layer is paperboard. The fifth layer is a foam layer. The sixth layer is paperboard. The first generally flat insulating form panel connects to the second generally flat insulating form panel by the use of a plurality of tying members. A desired amount of fluid concrete is poured between the first generally flat insulating form panel and the second generally flat insulating form panel to form a concrete wall.

Another method of forming insulated concrete structure provides a first generally flat insulating form panel that comprises at least a first layer, a second layer, and a third layer. The first layer is paperboard. The second layer is a foam layer. The third layer is paperboard. The method additionally provides a second generally flat insulating form panel that comprises at least a fourth layer, a fifth layer, and a sixth layer. The fourth layer is paperboard. The fifth layer is a foam layer. The sixth layer is paperboard. The first generally flat insulating form panel connects to the second generally flat insulating form panel by the use of a plurality of tying members. A desired amount of fluid concrete is poured between the first generally flat insulating form panel and the second generally flat insulating form panel to form a concrete wall. The fluid concrete cures. A wall-covering material attaches to the first generally flat insulating form panel using a fastener. The fastener directly fastens into the first layer.

A further method of forming an insulated concrete structure provides a first generally flat insulating panel that comprises at least a first layer, a second layer, and a third layer. The first layer is paperboard. The second layer is a foam layer. The third layer is paperboard. The method additionally provides a second generally flat form panel. The first generally flat insulating form panel connects to the second generally flat form panel by the use of a plurality of tying members. A desired amount of fluid concrete is poured between the first generally flat insulating form panel and the second generally flat form panel.

Yet another method of forming an insulated concrete structure provides a first generally flat insulating panel that comprises at least a first layer, a second layer, and a third layer. The first layer is paperboard. The second layer is a foam layer. The third layer is paperboard. The method additionally provides a second generally flat form panel. The first generally flat insulating form panel connects to the second generally flat form panel by the use of a plurality if tying members. A desired amount of fluid concrete is poured between the first generally flat insulating form panel and the second generally flat form panel. The fluid concrete cures. A wall-covering material attaches to the first generally flat insulating form panel using a fastener. The fastener directly fastens into the first layer.

Yet a further method of forming an insulated concrete structure that provides a first generally flat insulating panel that comprises at least a first layer, a second layer, a third layer, a fourth layer, and a fifth layer. The first layer is a foam layer. The second layer is paperboard. The third layer is a foam layer. The fourth layer is paperboard. The fifth layer is a foam layer. The method additionally provides a second generally flat insulating form panel that comprises at least a sixth layer, a seventh layer, an eighth layer, a ninth layer, and a tenth layer. The sixth layer is a foam layer. The seventh layer is paperboard. The eighth layer is a foam layer. The ninth layer is paperboard. The tenth layer is a foam layer. The first generally flat insulating form panel connects to the second generally flat insulating form panel by the use of a plurality if tying members. A desired amount of fluid concrete is poured between the first generally flat insulating form panel and the second generally flat insulating form panel.

According to one embodiment of the present invention, an insulated concrete wall assembly comprises a first generally flat insulating form panel. The first generally flat insulating form panel comprises at least a first layer, a second layer, and a third layer. The first layer is paperboard. The second layer is a foam layer. The third layer is paperboard. The first generally flat insulating form panel forms a plurality of slots that extend through the first, second, and third layers. A second generally flat insulating form panel comprises at least a fourth layer, a fifth layer, and a sixth layer. The fourth layer is paperboard. The fifth layer is a foam layer. The sixth layer is paperboard. The second generally flat insulating form panel forms a plurality of slots that extend through the fourth, fifth, and sixth layers. A desirable amount of cured concrete is located between the first and second generally flat insulating form panels. A plurality of tying members connect the first panel to the second panel.

According to another embodiment of the present invention, an insulated concrete wall assembly comprises a first generally flat insulating form panel, a second generally flat form panel, a desired amount of cured concrete, and a plurality of tying members. The first generally flat insulating form panel comprises at least a first layer, a second layer, and a third layer. The first layer is paperboard. The second layer is a foam layer. The third layer is paperboard. The first generally flat insulating form panel forms a plurality of slots that extend through the first, second, and third layers. A desirable amount of cured concrete is located between the first panel and the second panel. The plurality of tying members connect the first panel to the second panel and are located within the concrete.

Still yet another method of the present invention provides a first generally flat insulating panel that comprises at least a first layer, a second layer, and a third layer. The first layer is a foam layer. The second layer is paperboard. The third layer is a foam layer. The method additionally provides a second generally flat form panel. The first generally flat insulating panel connects to the second generally flat form panel by the use of a plurality of tying members. A desired amount of liquid concrete is poured between the panels. A wall-covering material attaches to the first generally flat insulating form panel using a fastener. The fastener directly fastens into the second layer.

### BRIEF DESCRIPTION OF THE DRAWINGS

Other advantages of the invention will become apparent upon reading the following detailed description and upon reference to the drawings.

FIG. 1 is a side view of a high-strength polymer foam/paperboard panel according to one embodiment;

FIG. 2 is a side view of a high-strength polymer foam/paperboard panel according to another embodiment;

FIG. 3 is a side view of a high-strength polymer foam/paperboard panel according to a further embodiment;

FIG. 4 is a perspective view of the high-strength polymer foam/paperboard panels being used in an insulated concrete form system according to one embodiment; and

FIG. 5 is a side view of a high-strength polymer foam/paperboard panel according to yet another embodiment.

FIG. 6 is a side view of a high-strength polymer foam/paperboard panel according to yet a further embodiment.

### DETAILED DESCRIPTION OF THE ILLUSTRATED EMBODIMENT

The present invention is directed to insulated concrete form (ICF) systems and methods of forming ICF systems that are lightweight and have high strength. The ICF systems of the present invention serve as a form for pouring concrete and as an insulating layer, when left in place with the poured structure. The ICF systems eliminate the need for additional insulation, such as fiberglass insulation, to provide insulation. The ICF systems eliminate the cost associated with installing additional insulation and with removing the forms from a poured concrete structure, when the form panels are left in place.

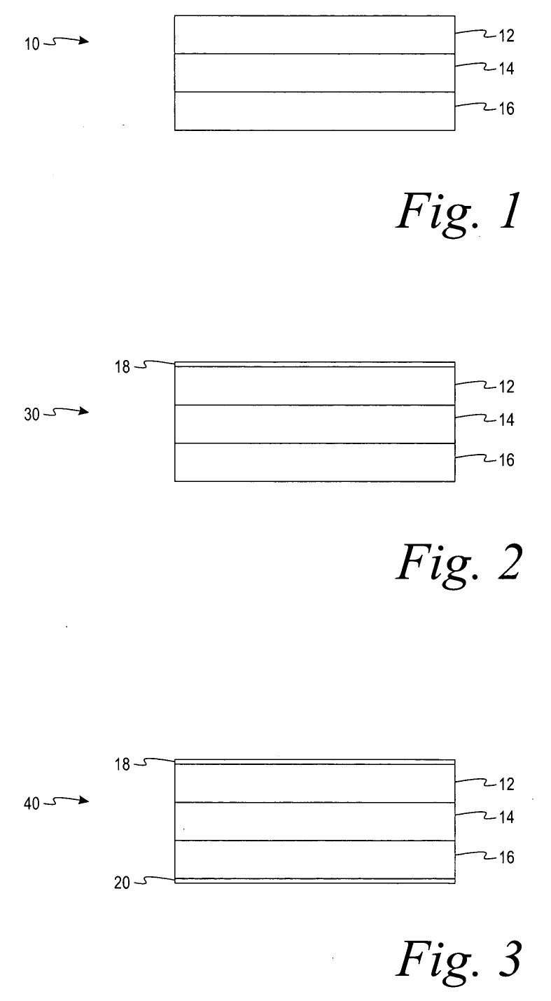

Referring to FIG. 1, a high-strength polymeric foam/paperboard panel 10 to be used in the ICF system of the present invention is shown. The high-strength polymeric foam/paperboard panel 10 comprises a first layer 12, a second layer 14, and a third layer 16. The second layer 14 of FIG. 1 is located between the first layer 12 and the third layer 16. It is contemplated that the panel may include additional layers, such as described below in conjunction with FIGS. 2 and 3. According to one embodiment, a series of slots, spaced twelve inches on center, is cut or formed near the edges of the panel through all of the layers to allow a tying member to join opposing panels when used as part of an ICF system.

First and Third Layers

The first and third layers 12, 16 of the panel 10 comprises paperboard. The term “paperboard” as used herein includes the broad classification of materials made from cellulosic fibers such as primarily wood pulp and recycled paper stock on board machines. The paperboard may be laminated paperboard that consists of a plurality of layers of paper adhesively secured to each other. Thus, the first and third layers 12, 16 may be comprised of several layers that may be different.

The paperboard may be, for example, kraft paper, chipboard, fiberboard and linerboard. Kraft paper as used herein includes pulp, paper or paperboard produced from wood fibers using a sulfate process. Chipboard as used herein includes paperboard that has been made from recycled paper stock. Fiberboard as used herein includes containerboard and vulcanized fiberboard. The fiberboard may be made from a combination of chemical pulp and recycled stock. Fiberboard as used herein also includes defibrated wood formed under heat and pressure and without the use of adhesives. The paperboard may also be a combination of one or more of the following: laminated paperboard, kraft paper, chipboard, fiberboard, linerboard, and saturated liner board.

The thickness of the first and third layers 12, 16 of the panel 10 is generally from about 0.05 to about 0.25 inch and, more specifically, from about 0.07 to about 0.18 inch. According to a further embodiment, the first and third layers of the panel comprises a kraft paper liner/paper honeycomb/kraft paper liner layer. The paper honeycomb is attached to the first and second kraft paper liners, by for example an adhesive.

Second Layer

According to one embodiment, the second layer 14 comprise an alkenyl aromatic polymer foam. The term “alkenyl aromatic polymer” as used herein includes polymers of aromatic hydrocarbon molecules that contain an aryl group joined to an olefinic group with only double bonds in the linear structure, such as styrene, α-methylstyrene, o-methylstyrene, m-methylstyrene, p-methylstyrene, α-ethylstyrene, α-vinylxylene, α-chlorostyrene, α-bromostyrene, and vinyl toluene. Alkenyl aromatic polymers also include homopolymers of styrene (commonly referred to as polystyrene), copolymers of styrene and butadiene, and rubber-toughened polystyrene (commonly referred to as high impact polystyrene or HIPS). The alkenyl aromatic polymer may be an oriented polystyrene (OPS). Another example of an alkenyl aromatic polymer foam is an extruded polystyrene foam.

According to another embodiment, the second layer 14 of the panel 10 may be formed by extruded polyolefin foam resins. One example of an extruded polyolefin foam that may be used in forming the first and third layers is an extruded polypropylene foam. It is contemplated that the polyolefin resins may be used in combinations with the alkenyl aromatic polymer resins. It is also contemplated that other foamed materials such as polyisocyanurate, polyurethanes, and polyesters may be used alone or in combinations with the polyolefins and alkenyl aromatic polymer foam resins. It is contemplated that the second layer 14 may be independently formed from different resins.

The second layer 14 of the high-strength polymeric foam/paperboard panel 10 may be formed by, for example, an extrusion process. It is contemplated that the second layer may be formed by other processes.

The thickness of the second layer 14 is generally from about 0.5 inch to about 3 inches. More specifically, the thickness of each of the second layer 14 is generally from about 1 inch to about 2 inches.

The density of the second layer 14 is generally from about 1 to about 3 lbs./ft.³ and, more specifically, from about 1.5 to about 2 lbs./ft.³

Additional Layers

It is contemplated that additional layers may be used to form the panels. It is contemplated that optional laminated surface coatings or facers may be added to the foam/paperboard panel. Examples of foam/paperboard panels with optional laminated surface coatings are shown in FIGS. 2 and 3. In FIG. 2, a panel 30 includes an optional laminated surface coating or facer 18 adjacent to and attached to the first layer 12. The panel 30 also includes a second layer 14 and a third layer 16 as described above. In FIG. 3, a panel 40 includes two facers 18, 20 that are adjacent to and attached to the respective first and third layers 12, 16. The panel 40 also includes the second layer 14. Thus, as shown in FIGS. 2 and 3, one or two facers may be added to the first and/or the third layers 12, 16.

The optional laminated surface coatings or facers 18, 20 may be made of materials such as polyolefins, high impact polystyrenes (HIPS), polyesters, metallized films, foils, or combinations thereof. Examples of polyolefins that may be used to form the facers include polypropylenes and polyethyelenes. One example of laminated surface coatings or facers is aluminum foil. It is contemplated that other materials may be used in forming the optional laminated surface coatings or facers.

The thickness of the optional laminated surface coatings or facers is generally from about 0.5 to about 3 mils and, more specifically, from about 0.7 to about 1 mil.

According to yet another embodiment shown in FIG. 5 a panel 50 includes five layers. In the panel 50, a first layer 112 is a foam layer, a second layer 114 comprises paperboard, and a third layer 116 is a foam layer. In addition to the three layers previously described, the panel 50 includes a fourth layer 122 comprising paperboard, and a fifth layer 124 being a foam layer.

The thickness of each of the first, third, and fifth layers 112, 116, 124 is generally from about 0.5 inch to about 3 inches. More specifically, the thickness of each of the first, third, and fifth layers 112, 116, 124 is generally from about 1 inch to about 2 inches. The thicknesses of the first, third, and fifth layers 112, 116, 124 may be different.

The densities of the first, third, and fifth layers 112, 116, 124 are generally from about 1 to about 3 lbs./ft.³ and, more specifically, from about 1.5 to about 2 lbs./ft.³

The thicknesses of the second and fourth layers 114, 122 of the panel 50 generally range from about 0.05 to about 0.25 inch and, more specifically, from about 0.07 to about 0.18 inch.

Attachment of the Insulating Foam/Paperboard Panel Layers

The first layer 12, the second layer 14, and the third layer 16 that form the panel 10 may be attached by several methods. For example, these layers may be attached to each other using an adhesive such as polyvinyl acetate, polyurethane, polyvinyl alcohol, or combinations thereof. It is contemplated that other adhesives may be used in attaching these layers.

The optional laminated surface coatings or facers 18, 20 may be attached to the is first and third layers 12, 16 by the use of an adhesive. Examples of suitable adhesives include ethylene vinyl acetate (EVA), a mixture of EVA in polyethylene, ethylene vinyl alcohol (EVOH), block copolymers comprising polymeric regions of styrene-rubber-styrene such as KRATON® made by Shell Chemical Company, and modified EVAs such as BYNEL® made by Dupont. It is contemplated that other suitable adhesives may be used.

The panel 10 is a generally flat board sheet that may be manufactured in a variety of sizes. The panel 10 ranges in size from about 2′×4′ (2 feet by 4 feet) to about 2′×8′ (2 feet by 8 feet).

Methods of Using

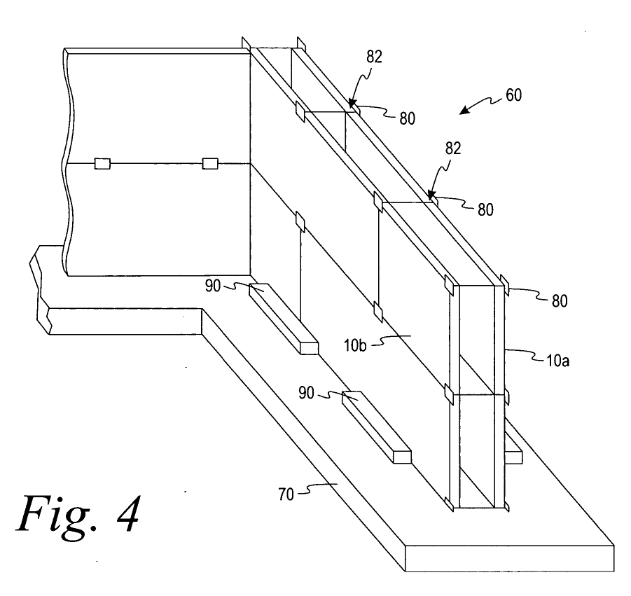

According to one method, at least two high-strength polymer foam/paperboard panels are provided, such as those depicted in FIG. 1 with panel 10. In forming the ICF system according to one embodiment, at least two panels and a plurality of tying members are provided. In FIG. 4, for example, an insulated concrete form system 60 is depicted that includes a first panel 10a and a second panel 10b, a foundation 70, a plurality of tying members 80, and two alignment cleat members 90. The tying members 80 attach a first panel 10a to a second opposing panel 10b using a plurality of slots 82 formed therethrough along the long edges of the panels. Specifically, the slots 82 extend through the first, second, and third layers of the first panel 10a, and the third, fourth, and fifth layers of panel 10b. The alignment cleat members 90 provide lateral support to the lowermost edges of the bottom panels and maintain the spacing of the lowermost edges of the panels on the surface of the foundation 70. To obtain the desired thickness of the poured concrete structure, the spacing of the lowermost edges of the panels is maintained. The tying members 80 typically are approximately the same length in a given embodiment so that the wall created by the form system 60 is of approximately uniform width. The length of tying members 80 is generally from about 8 inches to about 20 inches. Once the opposing panels, plurality of tying members, and alignment cleat members are in place, concrete may be poured into the form. It is further contemplated that additional bracing may be used to support the panels to further ensure that the panels do not blowout or fall over.

According to one embodiment, the alignment cleat members are made of wood. The alignment cleat members, however, may be made of metal. One specific example of an alignment cleat member is a 2″×4″ wood stud. It is contemplated that other sized wood studs may be used to form the alignment cleat member.

According to one embodiment, the tying members are made of plastic. The tying members, however, may be made of metal. One specific example of a tying member is the LITE-FORM® concrete systems tie. It is contemplated that other tying members may be used in the present invention. The tying members 80 are generally spaced at intervals of from about 2 inches to about 36 inches along the top and bottom edge portions of the panel 10. More specifically the tying members are spaced at intervals from about 2 inches to about 12 inches.

The foundation 70 is typically concrete, but it is contemplated that other materials may be used for the foundation, such as gravel or soil.

It is contemplated that wall-covering materials may be securely attached to the ICF panels after the concrete has been poured. Some non-limiting examples of wall-coverings are plywood or drywall. The paperboard layer of the present invention allows wall coverings to be firmly mounted into the foam/paperboard panel at any location. The ability to mount directly to the ICF panel allows for less burdensome installation of wall-coverings, since fasteners, such as drywall screws or nails, may be placed anywhere on the foam/paperboard panel. Consequently, the labor cost is decreased for installing wall-coverings.

According to a further alternate embodiment, a polymer foam/paperboard panel may be used in combination with a traditional wooden form or an aluminum form. In this embodiment, the polymer foam/paperboard panel is located on an inner-portion of the system, such that the inside wall of the form would be made from a polymer foam/paperboard panel. A plurality of tying members would then connect this polymer foam/paperboard panel to a wooden or aluminum panel. The wooden or aluminum panel is located as the outside wall of the form. Concrete is then poured between the polymer foam/paperboard panel and the opposing panel and allowed to cure. Once the concrete has cured, the outside wall of the form is removed, and the polymer foam/paperboard panel remains in place. The polymer foam/paperboard panel serves as insulation for the concrete structure.

According to yet another alternate embodiment, the polymer foam/paperboard panels may be used as a conventional concrete forming system. One polymer foam/paperboard panel is located as the inside wall of the form, and a second polymer foam/paperboard is placed as the outside wall of the form. A plurality of tying members connects the panels. The concrete is be poured between the foam/paperboard panels and allowed to cure. Once the concrete has cured, the foam/paperboard panels are removed, leaving in place a concrete structure having the shape of the form.

Properties of the Insulated Concrete Form System

The polymer foam/paperboard panel 10 generally has a stiffness from about 6000 lbs./in.² to about 7000 lbs/in.² as measured in accordance with ASTM C 203-99 “Standard Test Methods for Breaking Load and Flexural Properties of Block-Type Thermal Insulation.” More specifically, the polymer foam/paperboard panel 10 has a stiffness from about 6250 lbs/in.² to about 6750 lbs/in.².

The polymer foam/paperboard panel 50 generally has a stiffness from about 7700 lbs/in. to about 8700 lbs./in.² as measured in accordance with ASTM C 203-99 “Standard Test Methods for Breaking Load and Flexural Properties of Block-Type Thermal Insulation.” More specifically, the polymer foam/paperboard panel 50 has a stiffness from about 8000 lbs./in.² to about 8500 lbs./in.².

Alternative Layer Arrangement

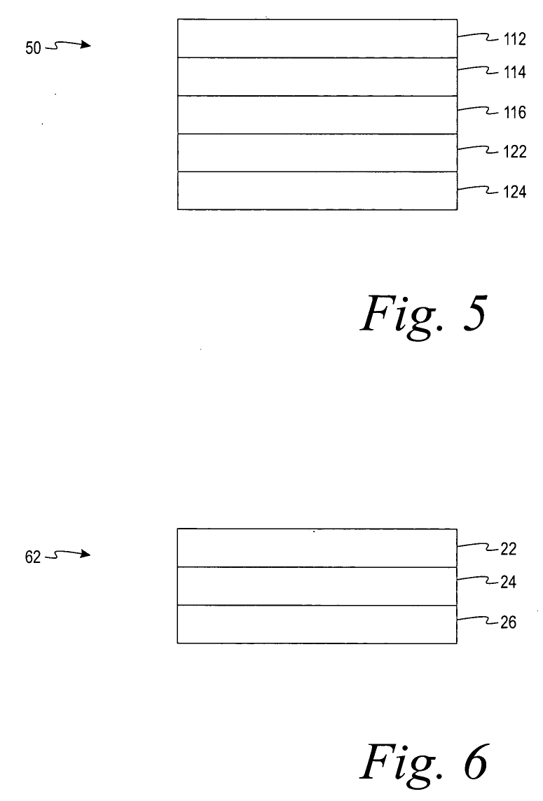

Turning to FIG. 6, yet another embodiment of a high-strength polymeric foam/paperboard panel 62 is shown. The panel 62 comprises a first layer 22, a second layer 24, and a third layer 26. The first and third layers 22, 26 comprise a foam similar to the second layer 14 of FIG. 1. The second layer 24 comprises paperboard, similar to the first and third layers 12, 16 of FIG. 1. The panel 62 may be used in a similar manner to panel 10 of FIG. 1.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A method of forming an insulated concrete structure, the method comprising the acts of:
providing a first generally flat insulating form panel comprising at least a first layer, a second layer, and a third layer, the first layer being paperboard, the second layer being a foam layer, and the third layer being paperboard;
providing a second generally flat insulating form panel comprising at least a fourth layer, a fifth layer, and a sixth layer, the fourth layer being paperboard, the fifth layer being a foam layer, and the sixth layer being paperboard;
connecting the first generally flat insulating form panel to the second generally flat insulating form panel using a plurality of tying members; and
pouring a desired amount of fluid concrete between the first generally flat insulating form panel and the second generally flat insulating form panel so as to form a concrete wall.

2. The method of claim 1, wherein the second and fifth layers comprise an alkenyl aromatic polymeric foam.

3. The method of claim 2, wherein the second and fifth layers are polystyrene foam layers.

4. The method of claim 1, wherein the second and fifth layers are polyolefin foam layers.

5. The method of claim 1, wherein the second and fifth layers have a density of from about 1.5 to about 3 lbs./ft.³.

6. The method of claim 1, wherein the thickness of each of the second and fifth layers is from about 0.5 inch to about 2 inches.

7. The method of claim 1, wherein the paperboard is a paperboard laminate.

8. The method of claim 1 further comprising the act of bracing the panels prior to pouring the desired amount of fluid concrete.

9. The method of claim 1, wherein the connecting using the plurality of tying members spaces the tying members from about 6 inches to about 16 inches on center along the panels.

10. The method of claim 1, wherein the flexural modulus of the first and second panels is from about 6000 lbs./in.² to about 7000 lbs./in.².

11. A method of forming an insulated concrete structure, the method comprising the acts of:
providing a first generally flat insulating form panel comprising at least a first layer, a second layer, and a third layer, the first layer being paperboard, the second layer being a foam layer, and the third layer being paperboard;
providing a second generally flat insulating form panel comprising at least a fourth layer, a fifth layer, and a sixth layer, the fourth layer being paperboard, the fifth layer being a foam layer, and the sixth layer being paperboard;
connecting the first generally flat insulating form panel to the second generally flat insulating form panel using a plurality of tying members;
pouring a desired amount of fluid concrete between the first generally flat insulating form panel and the second generally flat insulating form panel so as to form a concrete wall therebetween;
curing the fluid concrete; and
attaching a wall-covering material to the first generally flat insulating form panel using a fastener, the fastener being directly fastened into the first layer.

12. The method of claim 11, wherein the wall-covering material is drywall.

13. The method of claim 11, wherein the wall-covering material is plywood.

14. The method of claim 11 further comprising the act of:
attaching a wall-covering material to the second generally flat insulating form panel using a fastener, the fastener being directly fastened into the sixth layer.

15. A method of forming an insulated concrete structure, the method comprising the acts of:
providing a first generally flat insulating form panel comprising at least a first layer, a second layer, and a third layer, the first layer being paperboard, the second layer being a foam layer, and the third layer being paperboard;
providing a second generally flat form panel;
connecting the first generally flat insulating form panel to the second generally flat form panel using a plurality of tying members; and
pouring a desired amount of fluid concrete between the first generally flat insulating form panel and the second generally flat insulating form panel.

16. The method of claim 15 further comprising the acts of:
curing the fluid concrete; and
removing the second generally flat form panel.

17. A method of forming an insulated concrete structure, the method comprising the acts of:
providing a first generally flat insulating form panel comprising at least a first layer, a second layer, and a third layer, the first layer being paperboard, the second layer being a foam layer, and the third layer being paperboard;
providing a second generally flat form panel;
connecting the first generally flat insulating form panel to the second generally flat form panel using a plurality of tying members; and
pouring a desired amount of fluid concrete between the first generally flat insulating form panel and the second generally flat insulating form panel;
curing the fluid concrete; and
attaching a wall-covering material to the first generally flat insulating form panel using a fastener, the fastener being directly fastened into the first layer.

18. A method of forming an insulated concrete structure, the method comprising the acts of:
providing a first generally flat insulating form panel comprising at least a first layer, a second layer, a third layer, a fourth layer, and a fifth layer, the first layer being a foam layer, the second layer being paperboard, the third layer being a foam layer, the fourth layer being paperboard, and the fifth layer being a foam layer;
providing a second generally flat insulating form panel comprising at least a sixth layer, a seventh layer, an eighth layer, a ninth layer, and a tenth layer, the sixth layer being a foam layer, the seventh layer being paperboard, the eighth layer being a foam layer, the ninth layer being paperboard, and the tenth layer being a foam layer;
connecting the first generally flat insulating form panel to the second generally flat insulating form panel using a plurality of tying members; and
pouring a desired amount of fluid concrete between the first generally flat insulating form panel and the second generally flat insulating form panel.

19. An insulated concrete wall assembly comprising:
a first generally flat insulating form panel comprising at least a first layer, a second layer, and a third layer, the first layer being a foam layer, the second layer being paperboard, and the third layer being a foam layer, the first generally flat insulating form panel forming a plurality of slots extending through the first, second, and third layers;
a second generally flat form panel;
a desired amount of cured concrete being located between the first generally flat insulating foam panel and the second generally flat panel; and
a plurality of tying members connecting the first panel to the second panel and being located within the concrete.

20. The insulated concrete wall assembly of claim 19 further comprising a wall-covering attached to the first generally flat insulating form panel.

21. The insulated concrete wall assembly of claim 19, wherein the second generally flat form panel comprises at least a fourth layer, a fifth layer, and a sixth layer, the fourth layer being paperboard, the fifth layer being a foam layer, and the sixth layer being paperboard, the second generally flat insulating form panel forming a plurality of slots extending through the fourth, fifth, and sixth layers.

22. A method of forming an insulated concrete structure, the method comprising the acts of:
providing a first generally flat insulating form panel comprising at least a first layer, a second layer, and a third layer, the first layer being a foam layer, the second layer being paperboard, and the third layer being a foam layer;
providing a second generally flat form panel;
connecting the first generally flat insulating form panel to the second generally flat form panel using a plurality of tying members;
pouring a desired amount of fluid concrete between the first generally flat insulating form panel and the second generally flat form panel so as to form a concrete wall; and
attaching a wall-covering material to the first generally flat insulating form panel using a fastener, the fastener being directly fastened into the second layer.
